(19) United States
(12) Patent Application Publication
(10) Pub. No.: US 2007/0172737 A1
(43) Pub. Date: Jul. 26, 2007

(54) Electrochemical device and electrode

(75) Inventors: Hideki Oki, Kanagawa (JP); Yuri Nakayama, Kanagawa (JP); Kazuhiro Noda, Kanagawa (JP)

Correspondence Address: WOLF GREENFIELD & SACKS, P.C., 600 ATLANTIC AVENUE, BOSTON, MA, 02210-2206, US

(73) Assignee: SONY CORPORATION, Shinagawa-Ku Tokyo Japan (JP)

(21) Appl. No.: 10/589,043

(22) PCT Filed: Dec. 24, 2004
(86) PCT No.: PCT/JP04/19775

§ 371 Date: Aug. 10, 2006

(30) Foreign Application Priority Data
Feb. 13, 2004 (JP) 2004-035881

(51) Int. Cl. H01M 10/36; H01M 4/56; H01M 4/54; H01M 4/50; H01M 4/48; H01M 4/52; H01M 4/58; H01M 4/62

(52) U.S. Cl. 429/304; 429/224; 429/221; 429/220; 429/228; 429/231; 429/219; 429/218.1; 429/217; 429/231.6

(57) ABSTRACT

An electrochemical device having battery characteristics and an electrode used therefor. The electrochemical device has a first pole, a second pole, and an electrolyte, said first pole containing an active material having at least one element selected from the group consisting of 1B Group, 2B Group, 6A Group, 7A Group, and 8 Group of the short-form periodic table, and said electrolyte containing an element belonging to 2A Group and/or 3B Group of the periodic table. Interactions between the electrolyte and the active material cause the occlusion and release of said ions.

### TECHNICAL FIELD

The present invention relates to an electrochemical device, such as magnesium ion battery, and an electrode appropriate therefor.

### BACKGROUND ART

Much has been reported so far about researches into the lithium ion secondary battery which attracted attention because lithium (Li) has a larger capacity per unit volume than any other elements.

As devices are miniaturized for better portability in the future, importance will be attached to the development of a new battery with magnesium (Mg) which produces a lower electromotive force than lithium and yet has a large capacity per unit volume. (See Nature 407, 724-727 (2000), for example.) The magnesium ion secondary battery has a cathode which contains a molybdenum/sulfur compound (Mo₆S₆) as the active material. This compound has a lattice crystal structure as shown in FIG. 7. This battery is discharged as magnesium ions (Mg²⁺) are occluded into the lattice crystal structure of Mo₆S₆ as the active material of the cathode and is charged as occluded magnesium ions are released from the lattice crystal structure.

Unfortunately, the above-mentioned magnesium ion battery which is available now has twice as small capacity as the lithium ion secondary battery because of its small cathode capacity. The small cathode capacity is due to the fact that the crystals of Mo₆S₆ as the active material accounts for a large portion in the cathode (which has the lattice crystal structure as mentioned above) and the region for magnesium ion occlusion for discharging by conventional mechanism is restricted. Thus it is essential to develop a new cathode material which permits magnesium to fully exhibit its characteristic properties, thereby achieving a high capacity inherent in the magnesium ion battery.

The present invention was completed to address the above-mentioned problems. It is an object of the present invention to provide an electrochemical device (functioning as a battery) and an electrode therefor.

### DISCLOSURE OF THE INVENTION

The present invention is directed to an electrochemical device which comprises a first pole, a second pole, and an ionic conductor, said first pole containing an active material having at least one element selected from the group consisting of 1B Group, 2B Group, 6A Group, 7A Group, and 8 Group of the short-form periodic table, and said ionic conductor containing an element belonging to 2A Group and/or 3B Group of the periodic table.

According to the present invention, the first pole contains an active material which has at least one element selected from the group consisting of 1B Group, 2B Group, 6A Group, 7A Group, and 8 Group of the short-form periodic table, so that the active material and the ionic conductor perform ion occlusion and release through their interactions. This structure leads to a marked increase in the amount of ion occlusion and ion release in the first pole as compared with the conventional magnesium ion secondary battery which employs the cathode of lattice crystal structure for ion occlusion (at the time of discharging) and ion release (at the time of charging). Consequently, the electrochemical device of the present invention is capable of efficient ion occlusion and ion release in high capacity, and hence it exhibits outstanding characteristic properties when used as a battery.

### BRIEF DESCRIPTION OF THE DRAWINGS

FIG. 1 is a schematic diagram showing the mechanism of ion occlusion and ion release involved in the electrochemical device according to the present invention.

FIG. 2 is a schematic sectional view showing one example of the electrochemical device according to the present invention.

FIG. 3 is a graph showing measurements of charging and discharging in the electrochemical device according to the present invention, which is constructed as a magnesium ion secondary battery in one embodiment of the present invention.

FIG. 4 is a graph showing CV curves measured for the electrochemical device according to the present invention, which is constructed as a magnesium ion secondary battery in one embodiment of the present invention.

FIG. 5 is a graph showing charging-discharging curves measured for the electrochemical device according to the present invention, which is constructed as a magnesium ion secondary battery in one embodiment of the present invention.

FIG. 6 is a graph showing charging-discharging curves measured for a magnesium ion battery (in a comparative example) which has Mo₆S₆ as the active material of the cathode.

FIG. 7 is a schematic diagram showing the mechanism of charging and discharging in the cathode of the conventional magnesium ion secondary battery.

### BEST MODE FOR CARRYING OUT THE INVENTION

According to the present invention, the active material for the first pole should preferably be one or more (in mixture form) of the metal oxide or metal sulfide represented by the general formula (1) below.
MX (1)
(where M denotes any of Cr, Mn, Fe, Co, Ni. Cu, Zn, Pd, Ag, Pt, and Au, and X denotes O or S.)

For a higher capacity, the metal (M) in the general formula (1) should preferably be any of Co, Cu, Fe, and Ni.

The metal oxide or metal sulfide in the general formula (1) should be composed of M and X such that the ratio of M/X is from 0.3 to 3, preferably from 0.5 to 0.7. With a ratio outside the range specified above, the metal oxide or metal sulfide cannot be a stable compound.

The active material for the first pole should have an average particle diameter no smaller than 1 nm and no larger than 100 μm, preferably 1 to 1000 nm, more preferably 10 to 300 nm. The active material should have as small a particle diameter (of the order of nanometer) as possible so that it has a large surface area for interactions with said ions.

Moreover, the first pole should preferably be formed from the active material mixed with a conductive material and a polymeric binder so that the active material (which is nonconductive) permits the electrochemical reaction to proceed smoothly. The conductive material may be a mixture of graphite and carbon. The polymeric binder is not specifically restricted so long as it is capable of binding the active material and the conductive material. It is exemplified by polyvinylidene fluoride (PVdF).

Said ions include magnesium ions, aluminum ions, and calcium ions. In addition, the second pole should preferably be formed from magnesium, aluminum, or calcium in the form of simple substance or compound.

The ionic conductor should preferably be an electrolytic solution or a solid electrolyte. A typical example is a solution of Mg(AlCl₂EtBu)₂ in tetrahydrofuran (THF).

The electrochemical device according to the present invention may be a primary battery or a secondary battery. The former has unrestorable chemical energy and the latter is capable of charging and discharging electrical energy by reversible electrochemical reactions.

The embodiment of the present invention will be described in more detail with reference to the accompanying drawings.

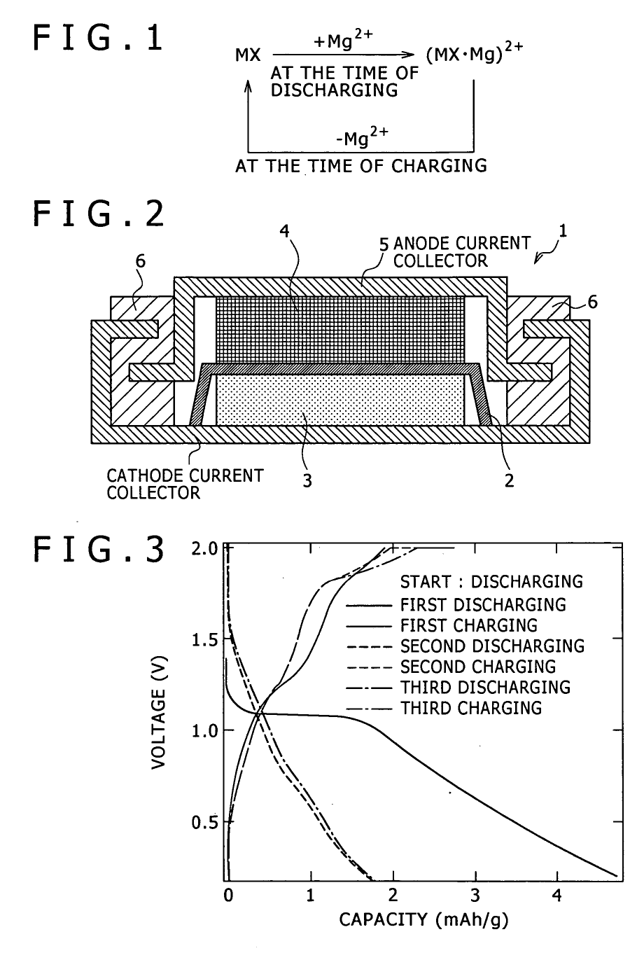

FIG. 1 is a schematic diagram showing how charging and discharging occur in the electrochemical device (as a secondary battery) according to the present invention, which is based on an active material of the metal oxide or metal sulfide (MX) represented by the general formula (1) above and magnesium ions as said ions.

As shown in FIG. 1, discharging occurs as (MX.Mg)²⁺ generates from interactions between magnesium ions (Mg²⁺) from the electrolyte and MX (which is the active material of the first pole), with the result of magnesium ions being occluded. On the other hand, charging occurs as (MX.Mg)²⁺ (which has generated at the time of discharging) returns to MX, thereby releasing magnesium ions. Incidentally, in the case where the electrochemical device of the present invention is constructed as a magnesium ion primary battery, only the interactions for discharging take place.

The conventional magnesium ion battery has a cathode made of a compound like Mo₆S₆ having the lattice crystal structure; therefore, it suffers the disadvantage that Mo₆S₆ crystals account for such a large portion of the cathode that the region for magnesium ion occlusion is limited and the discharging capacity or charging capacity is limited.

By contrast, the electrochemical device (as a battery) according to the present invention performs ion occlusion and release through interactions between said ions and the active material of the first pole and hence possesses a greatly increased discharging capacity or charging capacity, which is a desirable battery property.

FIG. 2 is a schematic sectional view showing one example of the electrochemical device (as a battery) according to the present invention. It is assumed that the battery is of coin-type cell structure.

The battery 1 has a cathode 3 and an anode 4 separated by a separator 2 from each other. The space in the battery 1 is filled with said electrolyte.

The cathode 3 is formed from a mixture of said active material represented by the general formula (1) above, said conductive material, and said polymeric binder.

The anode 4 may be formed by attaching a plate of metallic magnesium to the current collector 5.

The gasket 6 tightly seals the battery 1, prevents said electrolyte from leaking out, and electrically insulates the cathode 3 from the anode 4.

The battery 1 works by interactions between the active material of the cathode 3 and the ions generated from the electrolyte, said interactions resulting in ion occlusion for discharging and ion release (from the cathode 3) for charging.

The conventional magnesium ion battery has a cathode made of a compound like Mo₆S₆ having the lattice crystal structure; therefore, it suffers the disadvantage that Mo₆S₆ crystals account for such a large portion of the cathode that the region for magnesium ion occlusion is limited and the discharging capacity or charging capacity is limited. By contrast, the electrochemical device (as the battery 1) according to the present invention performs ion occlusion and release through interactions between said ions and the active material of the cathode 3 and hence possesses a greatly increased discharging capacity or charging capacity, which is a desirable battery property.

### EXAMPLES

The invention will be described in more detail with reference to the following examples.

### Example 1

This example demonstrates a magnesium ion secondary battery as the electrochemical device according to the present invention. The active material of the cathode is made of cobalt monosulfide (CoS) for magnesium ion occlusion and release. The cobalt monosulfide was found, by observation under an optical microscope, to have greatly varied particle diameters ranging from 3 to 30 μm.

(Preparation of Cathode)

First, a mixture was prepared from CoS, a carbon conductive material, and a polymeric binder. The carbon conductive material is a mixture of fine graphite powder and fine carbon powder. The former is a commercial product “KS6” having an average particle diameter of 6 μm, from Timcal Japan Co., Ltd., and the latter is a commercial product “KB” having particle diameters of the order of nanometers, from Ketjen Black International Co., Ltd. The polymeric binder is polyvinylidene fluoride (PVdF). After thorough mixing, the mixture was made into a slurry by dispersion into N-methylpyrrolidone (NMP), which is a solvent capable of dissolving the polymeric binder. The slurry was vacuum-dried and the dried product was thoroughly crushed. The resulting powder was made into a pellet having a current collector of stainless steel (SAS). Incidentally, the cathode active material is composed of CoS, graphite, KB, and PVdF in a weight ratio of 75:15:5:5.

(Preparation of Battery)

An electrochemical device (of coin-type cell structure) as shown in FIG. 2 was made in which the cathode (prepared as mentioned above) and an anode of metallic magnesium (Mg) plate are separated from each other by a separator of polyethylene glycol and which was filled with an electrolyte of Mg(AlCl₂EtBu)₂ dissolved (0.5 mol/L) in tetrahydrofuran (THF), 150 μL in total divided into two equal portions by the separator. This electrolyte is the one which was reported in Nature 407, 496-499 (2000).

(Measurement of Charging and Discharging)

The battery prepared as mentioned above was examined for charging and discharging performance at room temperature. Discharging was performed at a constant current of 0.5 mA until the voltage dropped to 0.2 V. Charging was performed at a constant current of 0.5 mA until the voltage reached 2 V and the charging current reached 0.1 mA at a constant voltage of 2 V. Measurement of discharging was carried out first. Incidentally, it was confirmed that the battery immediately after preparation did not decrease in voltage when left in the open circuit state.

FIG. 3 is a graph showing the results of measurements of charging and discharging. It is apparent from FIG. 3 that discharging in the first cycle takes place at a constant voltage in the neighborhood of 1.1 V. Surely, this is not due to the carbonaceous conductive material (as the constituent of the cathode) and the polymeric binder. Discharging in the first cycle suggests the battery reaction. Discharging in the second and third cycles is similar to that of a capacitor although the curve slightly deflects in the neighborhood of 0.8 V.

(Cyclic Voltammetry (CV) of Battery)

After examination for charging and discharging, the CV of the battery was measured at room temperature. The cycle of open circuit state (OCV)→0.2 V→2.0 V→OCV was repeated twice at 1, 5, and 10 mV/s. Measurement was carried out with the voltage not exceeding 2.0 V because there was the possibility of the electrolyte decomposing.

FIG. 4 is a graph showing the result of CV measurement. Each curve is dominated by capacitor components but has a peak in the neighborhood of 1.3 V which is presumably due to reduction of the cathode. There is also a peak in the neighborhood of 2 V which is presumably due to oxidation of the electrolyte. This peak could be due to decomposition of the electrolyte. It is impossible to assert that it is due to the battery reaction. The fact that the discharging capacity in the first cycle is larger than that in the second cycle suggests that the decomposition of the electrolyte takes place preferentially over discharging. However, it was confirmed that the electrochemical device continued to function as a secondary battery even after the second cycle. It was also confirmed that the oxidation-reduction peak in the neighborhood of 0.5 V is due to carbon.

### Example 2

This example demonstrates a magnesium ion secondary battery as the electrochemical device according to the present invention. The active material of the cathode is made of cobalt oxide (CoO) for magnesium ion occlusion and release. The cobalt oxide was found, by observation under an optical microscope, to have greatly varied particle diameters ranging from 3 to 30 μm.

(Preparation of Cathode)

First, a mixture was prepared from CoO, a carbon conductive material, and a polymeric binder. The carbon conductive material is a mixture of fine graphite powder and fine carbon powder. The former is a commercial product “KS6” having an average particle diameter of 6 μm, from Timcal Japan Co., Ltd., and the latter is a commercial product “KB” having particle diameters of the order of nanometers, from Ketjen Black International Co., Ltd. The polymeric binder is polyvinylidene fluoride (PVdF). After thorough mixing, the mixture was made into a slurry by dispersion into N-methylpyrrolidone (NMP), which is a solvent capable of dissolving the polymeric binder. The slurry was vacuum-dried and the dried product was thoroughly crushed. The resulting powder was made into a pellet having a current collector of stainless steel (SAS). Incidentally, the cathode active material is composed of CoO, graphite, KB, and PVdF in a weight ratio of 75:15:5:5.

(Preparation of Battery)

An electrochemical device (of coin-type cell structure) as shown in FIG. 2 was made in which the cathode (prepared as mentioned above) and an anode of metallic magnesium (Mg) plate are separated from each other by a separator of polyethylene glycol and which was filled with an electrolyte of Mg(AlCl₂EtBu)₂ dissolved (0.5 mol/L) in tetrahydrofuran (THF), 150 μL in total divided into two equal portions by the separator. This electrolyte is the one which was reported in Nature 407, 496-499 (2000).

(Measurement of Charging and Discharging)

The battery prepared as mentioned above was examined for charging and discharging performance at room temperature. Discharging was performed at a constant current of 0.5 mA until the voltage dropped to 0.2 V. Charging was performed at a constant current of 0.5 mA until the voltage reached 2 V and the charging current reached 0.1 mA at a constant voltage of 2 V. Measurement of discharging was carried out first. Incidentally, it was confirmed that the battery immediately after preparation did not decrease in voltage when left in the open circuit state.

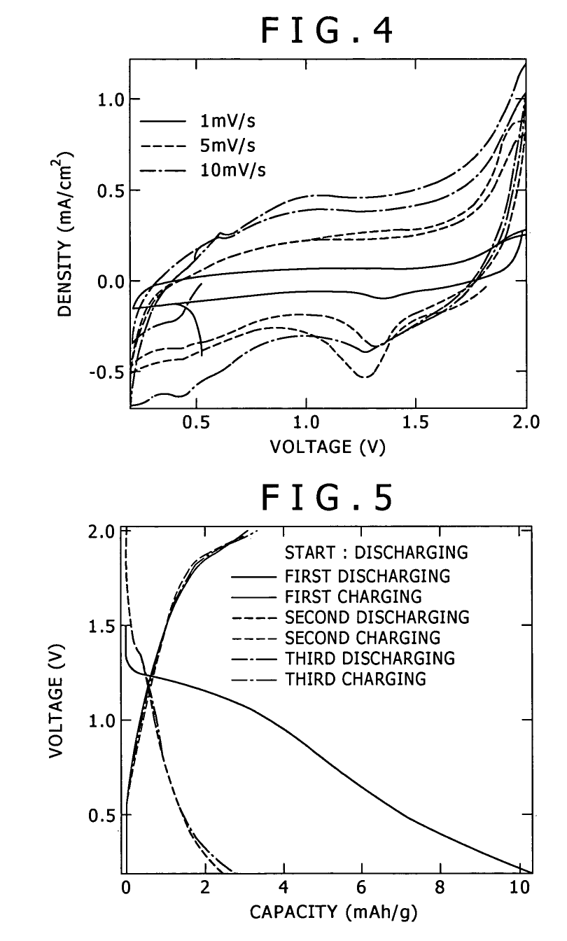

FIG. 5 is a graph showing the results of measurements of charging and discharging. It is apparent from FIG. 5 that discharging at a constant voltage is not observed unlike that in Example 1 (with CoS) but discharging takes place with a slight voltage drop in the neighborhood of 1.3 to 1.0 V. Discharging in the second and third cycles is similar to that of a capacitor as in Example 1 (with CoS).

### Comparative Example 1

This comparative example demonstrates a magnesium ion secondary battery in the same way as in Examples 1 and 2 except that the active material of the cathode was replaced by Mo₆S₆. The resulting battery was examined for charging and discharging performance in the same way as mentioned above.

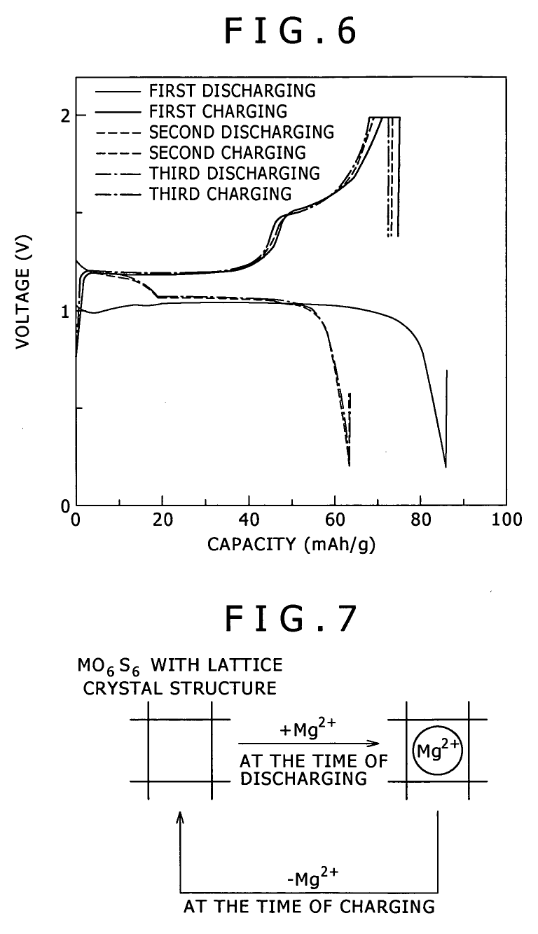

FIG. 6 is a graph showing the results of measurements of charging and discharging performance. It is noted that the battery has a capacity of 80 mAh/g at an electromotive force of about 1 V. The same performance as in the first cycle remained in the second and third cycles except for the reduced capacity. It has been reported that the behavior remains almost unchanged after 600 cycles. (See Nature 407, 724 (2000).) The electrochemical device according to the present invention is theoretically expected to have a capacity larger than 500 mAh/g after optimization. Nevertheless, the battery in this comparative example merely has a capacity of 122 mAh/g at the maximum.

The batteries in Examples 1 and 2, which had been tested for battery characteristics, were examined for crystal structure in the cathode immediately after charging and discharging. No change in crystal structure was found. It was also noticed that the crystal state remained unchanged from that before battery testing. The fact that the cathode material exhibited battery reactions as mentioned above suggests that reactions occur only on the surface of the active material.

Much has been reported so far that lithium ion secondary batteries are limited in capacity or poor in cycle characteristics if the active material of the cathode has a large particle diameter. (See J. Electrochem. Soc., 149, A627-A634 (2002).) Also, it has been reported that lithium ion batteries are required to be discharged at a sufficiently low voltage and charged at a sufficiently high voltage if they are to exhibit good charging-discharging performance. The electrolyte used in the above-mentioned examples could not have been experimented in the optimal range because it surely decomposes at 2.5 V and above. Moreover, CoS and CoO used as the active material of the cathode in the above-mentioned examples have a particle diameter as large as 3 to 30 μm. If a cathode active material with a particle diameter of the order of nanometers is employed as in the lithium ion battery mentioned above, it would be possible to increase the capacity by several hundreds times.

Therefore, it would be possible to realize a battery which has a larger capacity than the current lithium ion secondary battery through development of a new cathode active material having a smaller particle diameter, an optimized anode-constituting material, and a new electrolyte and electrolytic solution having a larger potential window.

The electrochemical device (as a magnesium ion battery) according to the present invention is expected to excel the lithium ion secondary battery in battery characteristics because magnesium ions and lithium ions as the anode-constituting material are the same in theoretical capacity and magnesium has a larger capacity per unit volume than lithium.

While the invention has been described above with reference to embodiments and examples, it will be variously modified within the scope thereof.

For example, the electrochemical device (as a primary or secondary battery) according to the present invention may adequately vary in shape, constitution, and material within the scope of the invention.

The foregoing description is concerned about examples that employ magnesium ions as said ions; however, such ions may be replaced by aluminum ions or calcium ions.

1. An electrochemical device which comprises a first pole, a second pole, and an ionic conductor, said first pole containing an active material having at least one element selected from the group consisting of 1B Group, 2B Group, 6A Group, 7A Group, and 8 Group of the short-form periodic table, and said ionic conductor containing an element belonging to 2A Group and/or 3B Group of the periodic table.

2. The electrochemical device as defined in claim 1, wherein the active material for the first pole is one or more (in mixture form) of the metal oxide or metal sulfide represented by the general formula (1) below.
MX (1)
(where M denotes any of Cr, Mn, Fe, Co, Ni, Cu, Zn, Pd, Ag, Pt, and Au, and X denotes O or S.)

3. The electrochemical device as defined in claim 2, wherein the metal oxide or metal sulfide represented by the general formula (1) is composed of M and X such that the ratio of M/X is from 0.3 to 3.

4. The electrochemical device as defined in claim 1, wherein the active material for the first pole has an average particle diameter no smaller than 1 nm and no larger than 100 μm.

5. The electrochemical device as defined in claim 1, wherein the first pole is formed from the active material mixed with a conductive material and a polymeric binder.

6. The electrochemical device as defined in claim 1, wherein said ions are magnesium ions, aluminum ions, or calcium ions.

7. The electrochemical device as defined in claim 1, wherein said second pole contains magnesium, aluminum, or calcium in the form of simple substance or compound.

8. The electrochemical device as defined in claim 1, wherein said ionic conductor is an electrolytic solution or a solid electrolyte.

9. The electrochemical device as defined in claim 1, which is a primary or secondary battery.
